(19) United States
(12) Patent Application Publication
(10) Pub. No.: US 2010/0148436 A1
(43) Pub. Date: Jun. 17, 2010

(54) Gaming Device and Method of Use with Balls of Differing Diameters

(76) Inventor: Joze Pececnik, Kamnik-Smarca (SI)

Correspondence Address: MCANDREWS HELD & MALLOY, LTD, 500 WEST MADISON STREET, SUITE 3400, CHICAGO, IL, 60661, US

(21) Appl. No.: 11/991,697

(22) PCT Filed: Sep. 7, 2006
(86) PCT No.: PCT/IB2006/002488

§ 371 Date: Mar. 1, 2010

(30) Foreign Application Priority Data
Sep. 8, 2005 (SI) P-200500257
Sep. 5, 2006 (US) 11470038

(51) Int. Cl. G07C 15/00

(52) U.S. Cl. 273/144 A

(57) ABSTRACT

A gaming device with orbs for the generation of a greater number of results is disclosed. The device draws out numbers in a single playing cycle in various games where a greater number of orbs are used and the result depends on the numbers that are marked in the openings by randomly laying orbs. The balls are, as a rule, of two dimensions—wherein the balls with the smaller dimensions are in the game for reasons of better scattering and greater attractiveness, while the balls with the greater diameter that represent the result or the drawn numbers are retained in random holes (2) on the plate (1′) of the cylinder (1) with the help of the offset plate (1″) of the cylinder (1).

### CROSS REFERENCE

This PCT Application claims priority to U.S. Non-Provisional Utility patent application Ser. No. 11/470,038, filed on Sep. 5, 2006, by inventor Jo\check{z}e Pe\check{c}e\check{c}nik, titled Gaming Device And Method Of Use With Balls Of Differing Diameters, filed on Sep. 5, 2006, and to Slovenian Patent Application No. P-200500257, filed Sep. 8, 2005, by inventor Jo\check{z}e Pe\check{c}e\check{c}nik, titled Gaming Device With Orbs For The Generation Of A Greater Number Of Results, which each of which is incorporated herein by reference.

### FIELD OF THE INVENTION

The present invention generally relates to a gaming device, and more particularly relate to a gaming device with substantially spherical balls where the gaming device can rapidly generate a randomly selected set of the substantially spherical balls, namely by drawing out each set during a single playing cycle within any of various different various games, where a greater diameter balls are used, and where the randomly selected set of the substantially spherical balls are those balls of larger diameter that are found in a respective set of opening in the gaming device.

### BACKGROUND

A problem with gaming devices that select a random set of balls is that these devices do not quickly and efficiently scatter the balls, position the balls, select each set, and then preparation for a new game. A reduction of time needed for the drawing of the random set of balls and in a manner that makes the game faster and more attractive to the gamers.

There are a large number of constructions of gaming devices and appliances which make possible the selection of random numbers with the help of stranding the balls or orbs in the marked openings.

The U.S. Pat. No. 5,536,007, for example, describes the construction of a device with one orb which is mounted below a screen with holes. By randomly occupying individual holes marked with numbers, a hit is enabled. The draw back of this device is, in addition to the number of results in a single game being small, the device does not have a simple mechanism provided for the repeated setting up of the device for the next game, thus making this device inappropriate for a large number of players.

U.S. Pat. No. 4,630,822 describes a game where a number of orbs are thrown onto a disc-shaped playing surface with unconnected marked openings. The orbs are then scattered with a special revolving object (a peg top) into the unconnected marked openings each having a different value. This solution is also inappropriate for a large number of players.

The gaming device described in the EP Patent Document No. 1,533,009 features a construction solution in the shape of a box which has stranding mechanisms made on the bottom playing surface that accept the balls or the orbs and laying openings on the top of the playing surface that are covered with special valves that open during the evacuation of the device and enable the drawing out of the balls or orbs—for example, by using a magnet stick with metal orbs.

All the described solutions are designed as gaming devices for a small number of players and are generally inappropriate for a large number of players typical of casino environments.

### SUMMARY

In one implementation, a gaming device with balls of differing diameters is provided. In a game played with the device, balls are shot by a generated air current over a spinning cylinder having appropriately marked holes. Balls of two or more dimensions are used. The balls with the smaller dimensions are used in the game to better scatter all of the balls and to provide an attractive game play environment. The balls with a greater diameter are those that are randomly selected to form a set thereof. The spinning cylinder can be made of double plates such that balls with a smaller diameter will pass through the double plates while balls having the larger diameter will be retained in marked spots of the double plates. The larger diameter balls that are retained in the marked spots of the double plates represent the randomly selected set of ball that constitute the result of a game played on the gaming device.

In another implementation, a gaming device has a ball ejection passage extending concentrically through top and bottom plates. Each plate has a plurality of circular holes there through, and the holes in the top plate are respectively associated with marking indicia. The top and bottom plates are being rotatable between an offset and non-offset positions thereof. In the non-offset position, both smaller and larger diameter substantially spherical balls above the top plate fall by gravity through the circular holes in the top and bottom plates, and larger diameter balls above the top plate are retained respective the holes in the top plate. In the offset position, smaller diameter balls above the top plate fall by gravity through a respective one hole in the top plate and through a respective one hole in the bottom plate, and the larger diameter balls above the top plate are retained respective holes in the top plate. The top plate is generally rotatable relative to the bottom plate. A stepping mechanism can be provided to rotate the top plate relative to the bottom plate between the offset and non-offset positions thereof without manual intervention during play of the gaming device. The balls can be ejected from below the bottom plate to above the top plate through the concentric ball ejection passage by a blower generating air currents.

### BRIEF DESCRIPTION OF THE DRAWINGS

A more complete understanding of the implementations may be had by reference to the following detailed description when taken in conjunction with the accompanying drawings wherein:

FIG. 1 shows a perspective view of an exemplary implementation of a gaming device with balls of differing diameters; and

FIG. 2 shows a top plan view of the gaming device seen in FIG. 1.

### DESCRIPTION

In reading the detailed description, the accompanying Figures may be referenced at the same time and considered as part of the detailed description.

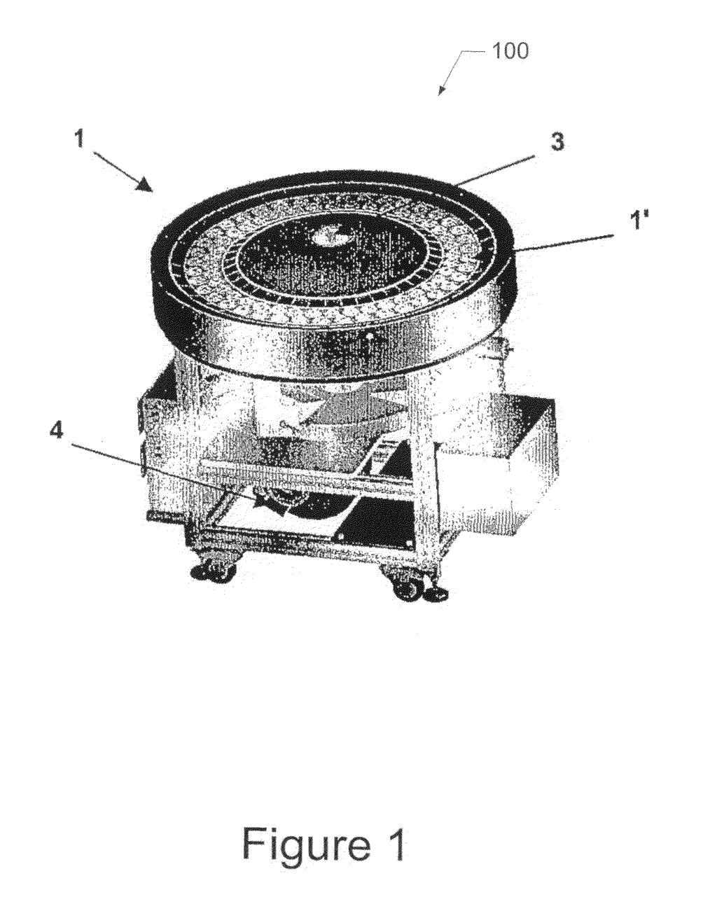

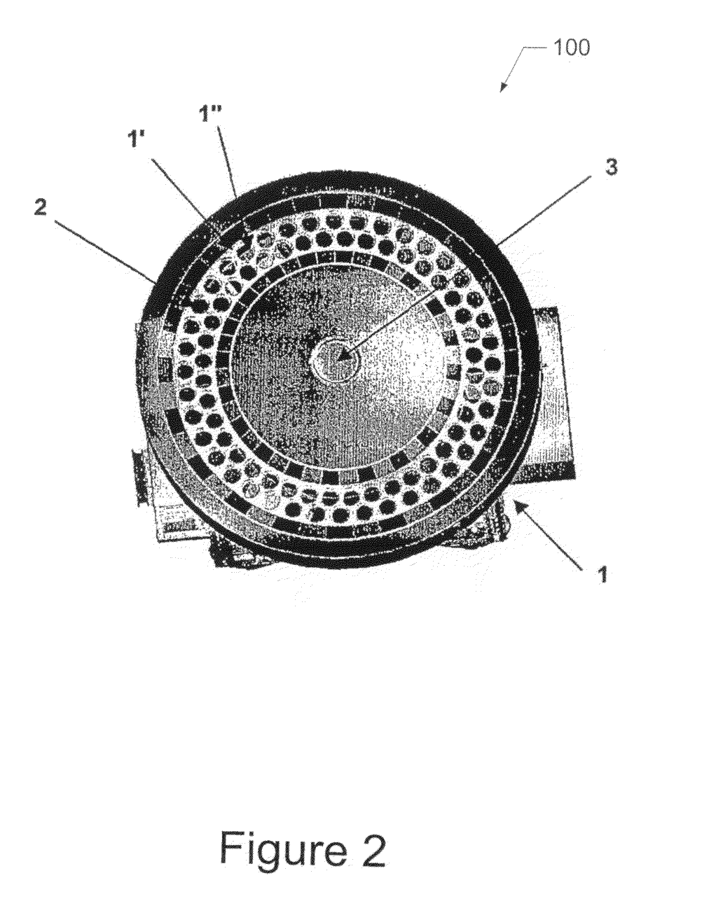

Referring to FIGS. 1-2, a gaming device 100, provided with substantially spherical balls (e.g.; orbs), can rapidly generate a randomly selected set of the balls. Gaming device 100 includes a revolving cylinder (1), a double plate (1′, 1″) in, for example, two rows. Each of a plurality of holes (2) has its own position marked with an appropriate designation (e.g.; numerical, color, etc). Cylinder (1) has a plate that is raised towards the center and an opening (3) constructed in the center for the exhaust or exit of the balls. That plate is connected at the bottom of the device 100 to a ball launching chamber. A mechanism enables the ejection of the balls from the launching chamber. In one implementation, the launching mechanism comprises a ventilating fan (4) for the generation of an air current. The balls have a weight and are made of a material (e.g.; Styrofoam, plastic) that enables the air current from ventilating fan (4) to shoot them over the cylinder (1).

Below the cylinder (1), the ball launching chamber is constructed so as to contain balls of two or more diameters or dimensions. The balls with the smaller diameter(s) are provided to better scattering all of the balls as well as to provide a greater attractiveness of the game. The balls with the largest diameter are the balls from which a randomly selected set thereof are drawn to arrive at a result of a game on the gaming device.

The basic dimension of the holes (2) in the plates (1′, 1″) is the same as the dimensions of the balls with the larger diameter. It is possible to mutually offset the position of the plates (1′, 1″) so that, in the case of mutual offset of plate (1″) with respect to plate 1′, an ball with a larger diameter will be retained in hole 2 of plate 1′ while the balls of lesser diameter will fall through the holes (2) of both plates (1′, 1″). By way of example, and not by way of limitation, a known stepping mechanism can be used to accomplishing this mutual offset for the position of the plates (1′, 1″), where the offsetting mechanism can be formed in a central control spot. As such, the offset can be accomplished without having to manually reach into the gaming device 100 during play.

Following the ejection of all the balls (both larger and smaller diameters), the randomly selected set of larger diameter balls that are retained in the holes 2 of plate 1′ can be read with the aid of sensors. Then, the stepping mechanism can be activated to remove the mutual offset of the position of the plates (1′, 1″) such that the randomly selected set of larger diameter balls that are retained in the holes 2 of plate 1′ will drop through the double plates (1′, 1″) and fall into the ball launch chamber where they wait for the next new game cycle or game to be played on gaming device 100. In this manner, gaming device 100 can quickly be immediately ready for a new game.

While preferred embodiments of this invention have been shown and described, modifications thereof can be made by one skilled in the art without departing from the spirit or teaching of this invention. The embodiments described herein are exemplary only and are not limiting. Many variations and modifications of the method and any apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims that follow, the scope of which shall include all equivalents of the subject matter of the claims.

1. A gaming device comprising a ball ejection passage extending concentrically through top and bottom plates each having a plurality of circular holes there through, the top and bottom plates being rotatable between:
a non-offset position thereof in which:
both smaller and larger diameter substantially spherical balls above the top plate fall by gravity through the circular holes in the top and bottom plates; and
larger diameter balls above the top plate are retained respective said holes in the top plate;
an offset position thereof in which:
smaller diameter balls above the top plate fall by gravity through one said hole in the top plate and through one said hole in the bottom plate; and
larger diameter balls above the top plate are retained respective said holes in the top plate.

2. The gaming device as defined in claim 1, wherein the top plate is rotatable relative to the bottom plate.

3. The gaming device as defined in claim 1, further comprising means for rotating the top plate relative to the bottom plate between the offset and non-offset positions thereof.

4. The gaming device as defined in claim 3, wherein the rotating means comprises a stepping mechanism to accomplish the offset and non-offset positions without manual intervention during play of the gaming device.

5. The gaming device as defined in claim 1, further comprising means for ejecting balls from below the bottom plate to above the top plate through the concentric ball ejection passage.

6. The gaming device as defined in claim 1, further comprising means for rotating the top plate.

7. The gaming device as defined in claim 1, wherein the plurality of holes in the top plate are respectively associated with marking indicia.

8. The gaming device as defined in claim 1, further comprising a blower generating air currents sufficient to eject balls from below the bottom plate to above the top plate through the concentric ball ejection passage.

9. A gaming device comprising a ball ejection passage extending concentrically through top and bottom plates each having a plurality of circular holes there through, the top and bottom plates being rotatable between:
a non-offset position thereof in which:
both smaller and larger diameter substantially spherical balls above the top plate fall by gravity through the circular holes in the top and bottom plates; and
larger diameter balls above the top plate are retained respective said holes in the top plate, and wherein the plurality of holes in the top plate are respectively associated with marking indicia;
an offset position thereof in which:
smaller diameter balls above the top plate fall by gravity through one said hole in the top plate and through one said hole in the bottom plate; and
larger diameter balls above the top plate are retained respective said holes in the top plate;
means for rotating the top plate relative to the bottom plate between the offset and non-offset positions thereof; and
means for ejecting balls from below the bottom plate to above the top plate through the concentric ball ejection passage.

10. The gaming device as defined in claim 9, wherein the top plate is rotatable relative to the bottom plate.

11. The gaming device as defined in claim 9, further comprising means for rotating the top plate.

12. The gaming device as defined in claim 11, wherein the means for ejecting balls comprises a blower for generating a current of air to eject balls from below the bottom plate to above the top plate through the concentric ball ejection passage.

13. The gaming device as defined in claim 9, wherein the rotating means comprises a stepping mechanism to accomplish the offset and non-offset positions without manual intervention during play of the gaming device.

14. A method for selecting a random set of balls in a game, the method comprising:
ejecting a plurality of differing diameter substantially spherical balls through a ball ejection passage extending concentrically through top and bottom plates, wherein each said plate has a plurality of circular holes there through;
rotating the top and bottom plates into an offset position thereof in which:
smaller diameter balls above the top plate fall by gravity through one said hole in the top plate and through one said hole in the bottom plate; and
larger diameter balls above the top plate are retained respective said holes in the top plate;
identifying the larger diameter balls above the top plate that are retained respective said holes in the top plate to arrive at the randomly selected set of balls; and
rotating the top and bottom plates into a non-offset position thereof in which:
both smaller and larger diameter substantially spherical balls above the top plate fall by gravity through the circular holes in the top and bottom plates; and
larger diameter balls above the top plate are retained respective said holes in the top plate.

15. The method as defined in claim 14, further comprising arriving at respective randomly selected sets by repeating the ejecting, the rotating to the offset position, and rotating to the non-offset position.

16. The method as defined in claim 14, wherein the ejecting comprises generating a current of air to eject balls from below the bottom plate to above the top plate through the concentric ball ejection passage.

17. The method as defined in claim 14, wherein the plurality of holes in the top plate are respectively associated with marking indicia.

18. The method as defined in claim 14, wherein the ejecting further comprises ejecting a greater number of smaller diameter balls through the ball ejection passage than that of the larger diameter balls.

19. An apparatus operable to perform the method of claim 14.

20. A game played by performing the method of claim 14.
